(19) United States
(12) Patent Application Publication
(10) Pub. No.: US 2006/0196241 A1
(43) Pub. Date: Sep. 7, 2006

(54) High nitrogen liquid fertilizer

(75) Inventors: James C. Phillips, Peachtree City, GA (US); Stacey L. Wertz, Conyers, GA (US); Anne K. Cothran, Conyers, GA (US)

Correspondence Address: PATENT GROUP GA30-43;GEORGIA-PACFIC CORPORATION, 133 PEACHTREE STREET, NE, ATLANTA, GA, 30303, US

(73) Assignee: Georgia-Pacific Resins, Inc., Atlanta, GA (US)

(21) Appl. No.: 11/357,409

(22) Filed: Feb. 21, 2006

Related U.S. Application Data
(63) Continuation-in-part of application No. 10/849,558, filed on May 20, 2004.

(51) Int. Cl. C05B 11/06

(52) U.S. Cl. 71/50

(57) ABSTRACT

The present invention is directed to liquid fertilizer composition having a high nitrogen content comprising an aqueous mixture of ammonium nitrate, an aqueous urea-formaldehyde resin solution and optionally urea that possess surprisingly depressed freeze points and salt-out temperatures.

### FIELD OF THE INVENTION

The present invention is directed to a liquid fertilizer composition having a high nitrogen content. The invention is particularly directed to an aqueous liquid fertilizer mixture of ammonium nitrate, a concentrated aqueous solution of a urea-formaldehyde resin and optionally urea. Liquid fertilizers of the present invention possess reduced freeze points and salt-out temperatures.

### BACKGROUND OF THE INVENTION

Nitrogen is an essential nutrient for supporting the growth and development of plants. Most plants grown to produce food, either for human or animal consumption, are given some form of nitrogen fertilizer. Fertilization of lawns also consumes large amounts of nitrogen fertilizers.

Urea continues to be the most widely used source of nitrogen fertilizer. While most of the urea is used in a granular form, liquid fertilizers using urea in some form continue to occupy an important segment of the fertilizer market. Probably the most common of the urea-based liquid fertilizers is an aqueous solution of urea and ammonium nitrate, identified as UAN solutions (Ammonium nitrate (AN) solutions without added urea also are used to some extent as a nitrogen fertilizer). The most concentrated of these aqueous solutions contains about 32% by weight nitrogen and is made from about 34 to 35% urea, 46 to 45% ammonium nitrate and the balance water. This concentrated fertilizer solution has a salt-out temperature of about 0 to −2° C., which limits the locations where it can be safely used without added complexity in transportation and storage. The salt-out temperature can be depressed further by increasing the water content and thus sacrificing the total nitrogen concentration of the aqueous fertilizer. So in cold climates, the maximum nitrogen content of such solutions is usually about 28% by weight.

Once applied to the soil, urea in such fertilizers is enzymatically converted to ammonia by urease, an enzyme produced by endogenous microorganisms in the soil. The ammonia then is hydrolyzed rapidly to ammonium ions. In the soil, some of the ammonium ions, whether from the hydrolyzed ammonia or ammonium nitrate, are assimilated directly by plants, but most are converted to nitrate by the process of nitrification. Once in the nitrate form, the nitrogen is more readily assimilated directly by plants.

Although in widespread use, one of the problems with using AN and UAN solutions as the nitrogen source is that some fraction of the nitrogen is lost after application in various ways, including volatilization as ammonia, denitrification to gaseous nitrogen and nitrate leaching. It has been estimated that the nitrogen loss for such fertilizers falls somewhere between 30% and 60%.

The fertilizer art also has developed a wide variety of liquid fertilizers based on the reaction between urea and formaldehyde. Such urea-formaldehyde resin fertilizers have been formulated and used as a way of providing a more controlled (sometimes characterized as an extended) release of the nitrogen values so that the availability of the nitrogen hopefully is tailored more closely to the time-course nitrogen requirements of the plants. In this way, it is thought that the nitrogen loss commonly associated with the quick release nitrogen fertilizers, such as UAN solutions, can be reduced. However, when formulated at high solids contents to maximize the total nitrogen value, these liquid fertilizers sometimes present their own stability problems.

Notwithstanding these inherent inefficiencies and potential problems, liquid fertilizers based on such formulations continue to be an attractive way of applying nitrogen fertilizers to plants. For that reason, the fertilizer art continues to search for improved compositions and ways for providing a concentrated nitrogen fertilizer liquid that is more stable and less prone to salting-out.

### DETAILED DESCRIPTION OF THE INVENTION

The present invention is based on the discovery that the addition of certain concentrated liquid fertilizers containing controlled release urea-formaldehyde resins into ammonium nitrate (AN) solutions and urea-ammonium nitrate (UAN) solutions can produce a liquid fertilized composition having an increase in its nitrogen content, relative to the AN and UAN solutions alone, and having an improved thermal (low temperature) stability.

Applicants have specifically discovered that the freezing point and the salt-out temperature of ammonium nitrate (AN) solutions and urea ammonium nitrate (UAN) solutions can be depressed by the addition of certain liquid fertilizer compositions of concentrated, controlled release urea-formaldehyde resins.

Thus, the present invention is directed to a liquid fertilizer composition of a high nitrogen content comprising an aqueous solution of a urea-formaldehyde resin, ammonium nitrate and optionally urea and also is directed to the related method of using the liquid fertilizer to fertilize plants.

The first component of the liquid fertilizer composition of the present invention is an aqueous concentrated urea-formaldehyde resin solution. This component provides a controlled release nitrogen property to the liquid fertilizer. This component also causes the ultimate liquid fertilizer composition to have improved freeze point and/or salt-out temperatures.

In accordance with the present invention, the aqueous concentrated urea-formaldehyde resin solution is prepared by reacting urea and formaldehyde and optionally ammonia under alkaline reaction conditions. The use of a formaldehyde (F) to urea (U) to ammonia (A) mole ratio (F:U:A) in the range of 0.5-2.5:1.0:0.0-0.5 is typical. There are a variety of processes known in the prior art for making such resins and in the broadest aspects of the present invention such processes and the resulting aqueous urea-formaldehyde solutions are intended to be embraced by the present invention. It is important that the reaction between the urea, formaldehyde and the optional ammonia be conducted under alkaline reaction conditions so that methylolated urea species are formed. Reaction temperatures between 50 and 100° C. are common, with a reaction time period as short as 30 minutes or as long as 5 hours being possible.

In a preferred embodiment of the present invention, the aqueous urea-formaldehyde resin solution is the aqueous resin solution described and claimed in Gabrielson, U.S. Pat. No. 6,632,262 (the Gabrielson patent). The Gabrielson patent specifically describes a controlled release urea-formaldehyde liquid fertilizer having a nitrogen level of at least 28% by weight nitrogen. According to the Gabrielson patent, formaldehyde (F), urea (U) and ammonia (A) are combined in an aqueous alkaline solution at an F:U:A mole ratio in the range of 0.6-1:1.0:0.25-0.35. The aqueous reaction mixture is heated for at least 0.75 hour at a temperature of 80° C. to 95° C., followed by cooling to less than 50° C. and adjusting the pH of the aqueous liquid to 9.0 to 10.5. Specific materials and procedures for preparing the urea-formaldehyde liquid fertilizer are aptly described in the Gabrielson patent and thus it is not necessary to repeat those teachings here. Instead, the disclosure of the Gabrielson patent, U.S. Pat. No. 6,632,262, is incorporated herein in its entirety by reference.

Briefly, to prepare the preferred aqueous urea-formaldehyde resin solution, formaldehyde, urea, and ammonia are combined in an alkaline solution at a formaldehyde:urea:ammonia mole ratio of about 0.6-1/1/0.25-0.35, preferably at a mole ratio of about 0.7-0.9/1/0.25-0.3, and most preferably at a ratio of about 0.8:1:0.27. All or most of the water present comes from a urea-formaldehyde concentrate, used as the main source of formaldehyde, and the ammonia source (aqua-ammonia). Water also may be added at the completion of the cook to adjust nitrogen content.

The solution is heated to about 80° C. to about 95° C., preferably to about 85° C. to about 90° C., and held for at least about 45 minutes, preferably about 45 minutes to about 120 minutes, more preferably about 60 to about 75 minutes, to ensure some triazone formation and to complete reaction of formaldehyde. Approximately 14 to 20% of the urea in the original mixture is in the form of triazone, preferably about 17 to about 20%. The pH of the solution is at least 7, preferably about 7.5 to about 10.5, and more preferably about 8.5 to about 9.5.

Following the initial reaction, the solution then is cooled to less than about 50° C., preferably to about ambient temperature and the pH is adjusted, as needed, to be within the range of about 9 to about 10.5, preferably from about 9.5 to about 10.

This process provides an aqueous urea-formaldehyde resin solution in which the triazone content, and mono-, di-, and tri-substituted urea species has been optimized for maximum stability.

The pH may be maintained or adjusted by adding a compound, such as triethanolamine, borax, sodium or potassium bicarbonate, or sodium or potassium carbonate, preferably triethanolamine, at the start of the reaction that will buffer the pH of the aqueous reaction mixture at the desired pH level. Alternatively, the pH may be maintained by addition of any suitable base during the reaction. While any base can be used to increase the pH of the reaction mix, preferably alkali metal hydroxides are used such as potassium hydroxide, lithium hydroxide, and sodium hydroxide.

In a preferred embodiment, the aqueous urea-formaldehyde resin solution has a free urea content of 45-55 wt %, a cyclic urea (trazone) content of 14-20 wt %, a monomethylol urea content of 25-35 wt % and a di/trimethylurea content of 5-15 wt % based on the weight of the urea-formaldehyde resin solution wherein the rest of the solution is composed predominately of water. The solids concentration of the aqueous urea-formaldehyde resin solution is typically between 60 and 92% by weight and preferably 80 and 92%, measured as the residual solids following heating at 105° C. Higher solids contents can be obtained by distilling the aqueous resin solution, usually under a vacuum.

The other component of the liquid fertilizer composition of the present invention is an aqueous solution of ammonium nitrate (AN) or an aqueous solution of urea-ammonium nitrate (UAN). AN solutions containing 21% nitrogen and UAN solutions containing 28%, 30% and 32% nitrogen are commercially available, and other customized concentrations and formulations can be obtained. The present invention is not limited to any particular source or concentration of AN and/or UAN solution. The UAN solution generally is prepared from 50% by weight ammonium nitrate and 50% by weight urea. Both continuous and batch-type process can be used for making AN and UAN solutions. In such processes, especially in the case of UAN solutions, concentrated urea and ammonium nitrate solutions are measured, mixed and cooled.

To make the liquid nitrogen fertilizer composition of the present invention, it only is necessary to blend together the aqueous urea-formaldehyde resin solution and the aqueous solution of ammonium nitrate (AN) or the aqueous solution of urea-ammonium nitrate (UAN) with thorough mixing. No specialized mixing equipment is needed. In some circumstances heating may be advisable or necessary to assist the initial, complete dissolution of the blended materials.

In accordance with the present invention, the aqueous urea-formaldehyde resin solution and the aqueous solution of ammonium nitrate (AN) or the aqueous solution of urea-ammonium nitrate (UAN) are mixed in a weight ratio (UF:AN or UF:UAN) of 90:10 to 10:90, often in the range of 80:20 to 20:80, more often in the range of 75:25 to 25:75 and most often in the range of 30:70 to 70:30, usually depending on the desired ratio of quick release and controlled release nitrogen desired in the final liquid fertilizer formulation.

A small amount of other additives also can be included in the liquid fertilizers of the present invention. For example, in specific applications, a herbicide, certain micronutrients, a coloring agent or dye and the like may safely be added without significantly degrading the thermal stability of the fertilizer composition.

The liquid fertilizer of the present invention has a broader temperature range over which it remains fluid with no appreciable precipitation of solids and thus it can be applied to plants in the same manner as any of the conventional liquid AN and UAN fertilizer solutions.

It will be understood that while the invention has been described in conjunction with specific embodiments thereof, the foregoing description and following examples are intended to illustrate, but not limit the scope of the invention. Other aspects, advantages and modifications will be apparent to those skilled in the art to which the invention pertains, and these aspects and modifications are within the scope of the invention.

### EXAMPLE 1 (REPEATED FROM EXAMPLE 2 OF U.S. Pat. No. 6,632,262)

The following ingredients were combined by adding in the following order: UFC, first addition of ammonium hydroxide, first addition of urea, second addition of ammonium hydroxide, and second addition of urea. The combination was heated to 85° C. to 90° C. and held for 60 minutes. The pH was monitored every 15 minutes and adjusted as necessary to maintain a pH between 8.6 and 10 using 25% caustic.

| Ingredient | Concentration | Weight % |
|---|---|---|
| UFC, 85% | 85 | 37.9 |
| Ammonium hydroxide | 28 | 0.5 |
| Urea, prill | 100 | 28.4 |
| Ammonium hydroxide | 8 | 15.4 |
| Urea, prill | 100 | 18.3 |
| Caustic | 25 | to adjust pH |
| Formic Acid | 23 | to adjust pH |
| Water | | to adjust % N |

The combination was then cooled to 25° C. and analyzed for % nitrogen and % free urea (by ¹³C-NMR).

Results: % Nitrogen was 29.9; pH was 10.1; % Free urea was 50% which corresponds to <50% quick release. Blends exhibited excellent stability.

The nitrogen concentration (and the solids concentration) can be increased by vacuum distillation of the resulting urea-formaldehyde resin liquid fertilizer product.

### EXAMPLE 2

Aqueous urea-formaldehyde resin solutions prepared substantially in accordance with the procedure of Example 1 were processed (using vacuum distillation) to a solids content of about 80% by weight and 92% by weight respectively. These aqueous urea-formaldehyde resin solutions are identified in the following Table as UF-1 and UF-2, respectively. Mixtures of the urea-formaldehyde resin solutions and a commercially available 21% by weight AN solution and a commercially available 32% by weight UAN solution were prepared at various weight ratios as shown in the following Table. The total solids content of the various aqueous formulations, measured as the residual solids following heating at 105° C., and the nitrogen content (weight %) of the aqueous formulations also are reported in the Table. The freeze points and the salt out temperatures for the various solutions were measured by the Galbraith Laboratories, Knoxville, Tenn. and also are reported in the following Table.

All of the blends embraced by the present invention stored at a temperature of 23-25° C. have remained free of solids for 180 days.

TABLE

| | | | Freeze | Salt-Out Temp. |
|---|---|---|---|---|
| SAMPLE | % Solids | % N | Point ° C. | ° C. |
| UF-1 | 80.7 | 34.6 | — | — |
| UF-2 | 92.1 | 39.7 | — | — |
| UAN | 80.9 | 31.9 | — | 0 |
| 50% UAN/50% UF-1 | 78.8 | 33.2 | <−19.7 | No distinct crystal |
| | | | | formation |
| 50% UAN/50% UF-2 | 84.4 | 35.7 | <−20 | No distinct crystal |
| | | | | formation |
| 70% UAN/30% UF-1 | 78.8 | 33.0 | <−19.9 | −3.1 |
| 70% UAN/30% UF-2 | 82.1 | 34.2 | <−20 | −6.6 |
| AN | 65.4 | 21.6 | — | 6 |
| 50% AN/50% UF-1 | 72.7 | 29.1 | <−20 | No distinct crystal |
| | | | | formation |
| 50% AN/50% UF-2 | 77.8 | 31.2 | <−20 | −10.3 |
| 70% AN/30% UF-1 | 69.5 | 26.8 | <−20 | −3.5 |
| 70% AN/30% UF-2 | 72.6 | 28.4 | <−20 | −0.7 |

The notation “no distinct crystal formation” indicates that the solution remained clear and that there was no visible formation of solids before the solution reached its freeze point.

The data in the Table shows that the addition of the urea-formaldehyde solution (UF-1 and UF-2) to the AN and/or UAN solutions suppressed the salt-out temperatures of both the AN and the UAN solutions. Moreover, because of the higher nitrogen content of the urea-formaldehyde solutions, it was possible to achieve nitrogen contents in the blends above 32% by weight, the maximum nitrogen content of UAN solutions.

While the invention has been described with respect to specific examples including presently preferred modes of carrying out the invention, those skilled in the art will appreciate that there numerous variations and permutations of the above described systems and techniques that fall within the spirit and scope of the invention as set forth in the appended claims.

I/We claim as follows:

1. An aqueous nitrogen fertilizer solution of ammonium nitrate, optionally urea and a urea-formaldehyde resin.

2. The aqueous nitrogen fertilizer solution of claim 1 wherein the urea-formaldehyde resin is prepared by reacting urea, formaldehyde and optionally ammonia in water under an alkaline reaction condition to yield an aqueous urea-formaldehyde resin solution.

3. The aqueous nitrogen fertilizer solution of claim 2 wherein the urea-formaldehyde resin is prepared by reacting urea, formaldehyde and ammonia at a formaldehyde/urea/ammonia mole ratio of 0.6-1/1/0.25-0.35.

4. The aqueous nitrogen fertilizer solution of claim 3 wherein the urea-formaldehyde resin is prepared by reacting a solution of urea, formaldehyde and ammonia at a temperature from 80° C. to 95° C. and a pH from 7.5 to 10.5 for 45 to 120 minutes.

5. The aqueous nitrogen fertilizer solution of claim 4 wherein the urea-formaldehyde resin wherein the triazone content, based on 100% resin solids, is 14 to 20% by weight.

6. The aqueous nitrogen fertilizer solution of claim 3 prepared by blending an aqueous urea-ammonium nitrate solution having a nitrogen content from 28 to 32% by weight with an aqueous solution of a urea-formaldehyde resin.

7. The aqueous nitrogen fertilizer solution of claim 6 wherein the urea-formaldehyde resin is prepared by reacting urea, formaldehyde and optionally ammonia in water under an alkaline reaction condition.

8. The aqueous nitrogen fertilizer solution of claim 7 wherein the urea-formaldehyde resin is prepared by reacting urea, formaldehyde and ammonia at a formaldehyde/urea/ammonia mole ratio of 0.6-1/1/0.25-0.35.

9. The aqueous nitrogen fertilizer solution of claim 8 wherein the urea-formaldehyde resin is prepared by reacting a solution of urea, formaldehyde and ammonia at a temperature from 80° C. to 95° C. and a pH from 7.5 to 10.5 for 45 to 120 minutes.

10. The aqueous nitrogen fertilizer solution of claim 9 wherein the urea-formaldehyde resin wherein the triazone content, based on 100% resin solids, is 14 to 20% by weight.

11. The aqueous nitrogen fertilizer solution of claim 2 wherein the aqueous urea-formaldehyde resin solution is mixed with an aqueous solution of ammonium nitrate (AN) or an aqueous solution of urea-ammonium nitrate (UAN) in a weight ratio (UF:AN or UF:UAN) of 90:10 to 10:90.

12. The aqueous nitrogen fertilizer solution of claim 3 wherein the aqueous urea-formaldehyde resin solution is mixed with an aqueous solution of ammonium nitrate (AN) or an aqueous solution of urea-ammonium nitrate (UAN) in a weight ratio (UF:AN or UF:UAN) of 90:10 to 10:90.

13. The aqueous nitrogen fertilizer solution of claim 5 wherein the aqueous urea-formaldehyde resin solution is mixed with and aqueous solution of ammonium nitrate (AN) or an aqueous solution of urea-ammonium nitrate (UAN) in a weight ratio (UF:AN or UF:UAN) of 90:10 to 10:90.

14. The aqueous nitrogen fertilizer solution of claim 7 wherein the aqueous urea-formaldehyde resin solution is mixed with an aqueous solution of ammonium nitrate (AN) or the aqueous solution of urea-ammonium nitrate (UAN) in a weight ratio (UF:AN or UF:UAN) of 90:10 to 10:90.

15. The aqueous nitrogen fertilizer solution of claim 9 wherein the aqueous urea-formaldehyde resin solution is mixed with an aqueous solution of ammonium nitrate (AN) or the aqueous solution of urea-ammonium nitrate (UAN) in a weight ratio (UF:AN or UF:UAN) of 90:10 to 10:90.

16. The aqueous nitrogen fertilizer solution of claim 2 wherein the aqueous urea-formaldehyde resin solution is mixed with an aqueous solution of ammonium nitrate (AN) or an aqueous solution of urea-ammonium nitrate (UAN) in a weight ratio (UF:AN or UF:UAN) of 75:25 to 25:75.

17. The aqueous nitrogen fertilizer solution of claim 3 wherein the aqueous urea-formaldehyde resin solution is mixed with an aqueous solution of ammonium nitrate (AN) or an aqueous solution of urea-ammonium nitrate (UAN) in a weight ratio (UF:AN or UF:UAN) of 75:25 to 25:75.

18. The aqueous nitrogen fertilizer solution of claim 5 wherein the aqueous urea-formaldehyde resin solution is mixed with and aqueous solution of ammonium nitrate (AN) or an aqueous solution of urea-ammonium nitrate (UAN) in a weight ratio (UF:AN or UF:UAN) of 75:25 to 25:75.

19. The aqueous nitrogen fertilizer solution of claim 7 wherein the aqueous urea-formaldehyde resin solution is mixed with an aqueous solution of ammonium nitrate (AN) or the aqueous solution of urea-ammonium nitrate (UAN) in a weight ratio (UF:AN or UF:UAN) of 75:25 to 25:75.

20. The aqueous nitrogen fertilizer solution of claim 9 wherein the aqueous urea-formaldehyde resin solution is mixed with an aqueous solution of ammonium nitrate (AN) or the aqueous solution of urea-ammonium nitrate (UAN) in a weight ratio (UF:AN or UF:UAN) of 75:25 to 25:75.
